(19) United States
(12) Patent Application Publication
(10) Pub. No.: US 2008/0312105 A1
(43) Pub. Date: Dec. 18, 2008

(54) Sensor For Biomolecules and a Method of Analysis Using Said Sensor

(75) Inventors: Johannes Bacher, Leonberg (DE); Andreas Boos, Bondorf (DE); Gerd Luedke, Holzgerlingen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,076

(22) PCT Filed: Dec. 15, 2006
(86) PCT No.: PCT/IB06/54883

§ 371 Date: Jun. 19, 2008

(30) Foreign Application Priority Data
Dec. 21, 2005 (EP) 05112544.1

(51) Int. Cl. C40B 50/18; C40B 60/12

(52) U.S. Cl. 506/32; 506/39

(57) ABSTRACT

Disclosed is a method of preparing a sensor for the analysis of a sample fluid, said sample fluid containing one or more target molecules. The method comprises the step of introducing said sample fluid into a chamber equipped with a porous substrate, one or more probe molecules being applied to said porous substrate and said probes being able to specifically bind to said one or more target molecules. The method further comprises the step of moving said substrate and said chamber relatively to each other in order to force said sample fluid through the pores of said porous substrate and to capture the one or more target molecules with the one or more probe molecules. Also disclosed is a sensor for the analysis of a sample fluid.

The present invention relates to a method of preparing and using a sensor for the analysis of a sample fluid. The present invention also relates to an improved sensor for the analysis of biomolecules. In particular, the invention relates to an improved and efficient method of preparing and using a sensor for the analysis of biomolecules in a biological sample. During operation, the sensor comprises a chamber for receiving the biological sample and a substrate included in said chamber, said substrate having probes applied thereto for binding to said biomolecules and said method includes a step wherein the substrate and the chamber are moved relatively to each other. More specifically, the invention relates to a sensor finding useful applications in microarray assays.

The presence and concentration of specific target molecules, such as but not limited to, DNA, RNA or proteins, in a biological sample containing one or more other molecules can be determined by using the complex binding of these target molecules with capture molecules. In the case of the traditional Western/Southern/Northern Blot, the target molecule is immobilized on the blot surface and subsequently detected by a soluble detection molecule. For ELISA (enzyme-linked immunosorbent assay) or microarray based test, it is the capture molecule that has been immobilized instead. In the microarray technique, a set of specific probe molecules, each of which being chosen in order to interact specifically with one particular target, are immobilized at specific locations of a solid surface. On the other hand, the target molecules are labeled by a detectable label molecule (e.g. a fluorophore or a magnetic bead). By contacting said solid surface with the biological sample, the target molecules will be fixed at the locations corresponding to their specific probes. The detection of the target molecules and the assessment of their concentration in the biological sample will then be operated respectively via the localization and the measurement of the intensity of the signals produced by the detectable molecules bound to the target. Due to the planar surface of standard microarrays, molecule transport within the biological sample fluid is mostly governed by diffusion laws. As these arrays have a considerable surface area, several hours of hybridization time may be required to obtain sufficient binding. The diffusion limitation effect can be somewhat reduced by agitation, liquid transport (pumping) or surface acoustic waves. However, due to the need to use smaller and smaller biological sample volumes and the resulting thin layer of liquid on top of the substrate, the efficiency of such agitation is low and does not allow turbulent mixture directly on the surface. In addition, standard microarrays require a washing step to remove this residual fluid layer from the top of the array prior to a measurement. This effectively limits or eliminate the possibility to use such a microarray for kinetic measurements where a series of consecutive measurements at different time points (to improve dynamic range of measurement) and/or temperature (to improve specificity by reducing the impact of unspecific binding) provides valuable additional information.

Such a method is disclosed for instance in WO03/004162 wherein a surface is arrayed with 3 distinct oligonucleotide DNA probes and is hybridized to a biological sample pool of 3 distinct complementary DNA targets. The targets are modified with a fluorescent label (fluorescein isothiocyanate) to permit direct detection on the surface. As the biological sample is contacting the surface, specific targets are captured from solution by the probes onto the surface and detection is performed by an epi-fluorescence microscope. WO/03004162 discloses several improvements to the general method described above such as the use of a porous substrate in order to permit the biological sample to contact the probes by flowing through the surface, optionally via the use of a pumping system. This approach has the advantage to considerably fasten hybridization. Another improvement is the use of a thermal chamber for controlling the temperature of the biological sample. Hybridization being a temperature-dependant phenomenon, temperature control provides advantages, e.g. for nucleic acid analyses.

However, pumping systems are both expensive and a potential source of leakage, and require frequent maintenance. Additionally, the presence of air in the circuit is very often difficult to avoid, which results in the formation of an excessive amount of foam interfering with the detection process.

There is therefore a need in the art for an improved and more efficient method to fasten hybridization of biomolecules on a substrate. There is also a need in the art for a less time-consuming analytical method using an equipment which is both inexpensive and easy to maintain.

As used herein, and unless stated otherwise, the term <<type>>, when applied to a target molecule or biological compound, designates a group of compounds which are related by their molecular structure. Exemplary types of target molecules involved in the present invention include, but are not limited to, DNA biological compounds, RNA biological compounds, polypeptides, enzymes, proteins, antibodies and the like.

As used herein, and unless stated otherwise, the term <<microarray assay>> designates an assay wherein a sample, preferably a biological fluid sample (optionally containing minor amounts of solid or colloid particles suspended therein), containing target biological compounds is contacting (e.g. flowing through) a membrane containing a multiplicity of discrete and isolated regions across a surface thereof, each of said regions having one or more probes applied thereto and each of said probes being chosen for its ability to bind specifically with a target biological compound.

As used herein, and unless stated otherwise, the term <<target>> designates a molecular compound fixed as a goal or point of analysis. It includes molecular compounds such as but not limited to nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, monoclonal antibodies, receptors, transcription factors, and the like), antigens, ligands, haptens, carbohydrates and related compounds (e.g. polysacharides, oligosacharides and the like), cellular organelles, intact cells, and the like.

As used herein, and unless stated otherwise, the term <<probe>> designates an agent, immobilized onto the surface of a substrate and/or into the substrate, being capable of some specific interaction with a <<target>> that is part of the sample when put in the presence of or reacted with said target, and used in order to detect the presence of said target. Probes include molecular compounds such as, but not limited to, nucleic acids and related compounds (e.g. DNAs, RNAs, oligonucleotides or analogs thereof, PCR products, genomic DNA, bacterial artificial chromosomes, plasmids and the like), proteins and related compounds (e.g. polypeptides, monoclonal antibodies, receptors, transcription factors, and the like), antigens, ligands, haptens, carbohydrates and related compounds (e.g. polysacharides, oligosacharides and the like), cellular organelles, intact cells, and the like.

As used herein, and unless stated otherwise, the term <<label>> designates an agent, which is readily detectable by suitable means so as to enable the detection of its physical distribution and/or the intensity of the signal delivered such as, but not limited to, luminescent molecules (e.g. fluorescent agent, phosphorescent agent, chemiluminescent agents, bioluminescent agents and the like), coloured molecules, molecules producing colours upon reaction, enzymes, magnetic beads, radioisotopes, specifically bindable ligands, microbubbles detectable by sonic resonance and the like.

As used herein, and unless stated otherwise, the term <<tag>> designates the action of bringing a label in the presence of a probe, or linking or interacting (e.g. reacting) a label with a probe.

Broadly speaking, this invention relates in a first aspect to a method of preparing a sensor for analysis of a sample fluid containing target molecules, said method consisting in moving a porous membrane on which probe molecules are applied, relatively to a chamber containing said sample fluid. This invention also relates in a second aspect to sensor comprising a chamber, a porous substrate with probe molecules applied thereto, a mean for introducing a sample fluid containing target molecules into the chamber and a mean for moving said porous substrate relatively to the chamber.

In its broadest acceptation and in a first aspect, the present invention relates to a method of preparing or using a sensor for the analysis of a sample fluid containing one or more target molecules, said method comprising the steps of:

1) introducing said sample fluid into a chamber equipped with a porous substrate, on which one or more probe molecules are applied, and said probes being able to specifically bind to said one or more target molecules, and

2) moving said substrate and said chamber relatively to each other in order to force said sample fluid through the pores of said porous substrate and to capture the one or more target molecules with the probe molecules.

The method of the present invention is especially useful when the one or more target molecules present in the sample, preferably the fluid sample, to be analyzed are molecules such as but not limited to, the following:
oligopeptides having from about 5 amino-acid units to 50 amino-acid units,
polypeptides having more than 50 amino-acid units,
proteins including enzymes,
oligo- and polynucleotides,
antibodies, or fragments thereof,
RNA, and
DNA.

For certain target molecules, a denaturation step may be beneficial, e.g. double stranded DNA can be separated into single strands in order to allow specific binding of the single strands to the capture probes spotted on the membrane. Such a denaturation step can be implemented in a convenient manner for instance by heating up either the substrate (wafer or membrane) or the sample, or both. When the sample is heated in such a denaturation step, an optional cooling step may be performed in order to keep the strands separated.

The labels used to tag said target biological compounds in a first step of the method, and ultimately permit their detection in a last step of the method, can be of luminescent (fluorescent, phosphorescent, chemioluminescent), radioactive, enzymatic, calorimetric, sonic (e.g. resonance of micro-bubbles) or magnetic nature. Specifically bondable ligands can be used in place of a label. In this last case, the ligand will be bound in a next step with a compatible label bearing agent.

Suitable fluorescent or phosphorescent labels are for instance but are not limitated to fluoresceins, Cy3, Cy5 and the likes.

Suitable chemioluminescent labels are for instance but are not limitated to luminol, cyalume and the likes.

Suitable radioactive labels are for instance but are not limitated to isotopes like ¹²⁵I or ³²P.

Suitable enzymatic labels are for instance but are not limitated to horseradish peroxidase, beta-galactosidase, luciferase, alkaline phosphatase and the likes.

Suitable calorimetric labels are for instance but are not limited to colloidal gold and the likes.

Suitable sonic labels are for instance but are not limitated to microbubbles and the likes.

Suitable magnetic beads are for instance but are not limitated to Dynabeads and the likes.

Each target molecule can be tagged with up to about 300 identical labels (during an eventual PCR amplification step for instance) in order to increase sensibility. As an optional step, unbound labels not incorporated into the target molecule and still present in the sample fluid may be removed from the sample fluid by means of chemical and/or physical treatments (e.g. chemical PCR purification, dialysis or reverse osmosis) in order to reduce the background signal during later measurements.

The sample fluid can be from industrial or natural origin. Examples of sample fluids suitable for performing the method of this invention may be, but are not limited to, body fluids such as sputum, blood, urine, saliva, faeces or plasma from any animal, including mammals (especially human beings), birds and fish. Other non-limiting examples include fluids containing biological material from plants, nematodes, bacteria and the like. The only requirement for a suitable performance of the method of this invention is that said biological material is present in a substantially fluid, preferably liquid form, for instance in solution in a suitable dissolution medium. The volume of the sample fluid to be used in the method of this invention can take any value between about 5 μl and 1 ml, preferably between about 50 μl and 400 μl.

In many cases, it is desirable to incorporate a buffer (e.g. a hybridization buffer) either directly into the sample fluid to be analyzed or as an integral part of the detection unit (e.g. added as a fluid or in lyophilized form either above or below the substrate), thus eliminating the need for a separate hybridization buffer storage area.

The substrate present in the test chamber presents two surfaces, an upper surface and a lower surface. Said substrate is porous in order to permit the sample fluid to be forced through said membrane from the upper surface to the lower surface and/or from the lower surface to the upper surface.

The porous substrate may include a network having a plurality of pores, openings and/or channels of various geometries and dimensions. The substrate may be nanoporous or microporous, i.e. the average size of the pores, openings and/or channels may suitably be comprised between 0.05 μm and 10.0 μm, preferentially between 0.1 μm and 1.0 μm, more preferentially between 0.3 and 0.6 μm. The pore size distribution may be substantially uniform or it may have a polydispersity from about 1.1 to about 4.0, depending upon the manufacturing technology of said substrate. The surface corresponding to the pores, openings or channels may represent between about 1 and 99%, preferably from about 10% to 90%, and more preferably from about 20% to 80%, of the total surface of either the upper surface or the lower surface of the porous substrate.

The thickness of the substrate, e.g. the membrane, is not a limiting feature of this invention and it can vary from about 10 μm to 1 mm, preferably from 50 μm to 400 μm, more preferably from 70 μm to 200 μm. The shape of the substrate, e.g. the membrane, is not a limiting feature of the present invention. It may be circular, e.g. with a diameter ranging between about 3 and 15 mm, but the method of the present invention can also be applied to any other substrate shape and/or size.

The porous substrate onto which the probes are applied (e.g. spotted) is not a limiting feature of this invention and therefore can be made of any material already described in the art as a suitable substrate for biomolecule immobilization on porous substrate. Non-limitative examples of such materials typically include:

organic polymers such as polyamide homopolymers or copolymers (e.g. nylon), thermoplastic fluorinated polymers (e.g. PVDF), polyvinylhalides, polysulfones, cellulosic materials such as nitrocellulose or cellulose acetate, polyolefins or polyacrylamides and
inorganic materials such as glass, quartz, silica, other silicon-containing ceramic materials, metal oxide materials such as aluminium oxides, and the like.

These substrate materials can be inactivated or they can be activated at at least part of their surface. If activated, the activation can be performed by a chemical or a physical treatment. Suitable means of activation include, but are not limited to, plasma, corona, UV or flame treatment, and chemical modification. Depending upon the kind of material, suitable chemical modifications include, but are not limited to, introduction of quaternary ammonium ions (e.g. into polyamides), solvolysis (e.g. hydrolysis), derivatization of amide groups to amidine groups (e.g. in polyamides), hydroxylation, carboxylation or silylation. A non-limitative example of a substrate material not requiring activation for a suitable performance of the method of the invention is nylon (polyamide homopolymers) especially when used for DNA or RNA analysis since it has an intrinsic affinity for oligo- and polynucleotides.

The probes used for the present invention should be suitably chosen for their affinity to the target biological compounds or their affinity to relevant modifications of said target biological compounds. For example, if the target biological compounds are DNA, the probes can be, but are not limited to, synthetic oligonucleotides, analogues thereof, or specific antibodies. A non-limiting example of a suitable modification of a target biological compound is a biotin substituted target biological compound, in which case the probe may bear an avidin functionality.

In a preferred embodiment of the present invention, more than one different probes are applied on the substrate and in a even more preferred embodiment, multiple different probes are spotted in an array fashion on physically distinct locations along one surface of said substrate in order to allow measurement of different targets in parallel.

In order to more easily support subsequent detection and identification, one or more additional spots (e.g. for intensity calibration and/or position detection) can be spotted as well onto the surface of the substrate.

Following spotting, the probes become immobilized onto the surface of the substrate, either spontaneously due to the substrate (e.g. membrane) inherent or acquired (e.g. via activation) properties, or through an additional physical treatment step (such as, but not limited to, cross-linking, e.g. through drying, heating or through exposure to a light source).

In order to improve the shelf-live of the substrate (e.g. membrane) and the probes attached thereon, drying the membrane when the membrane is not in use may be helpful. The membrane is thereafter rehydrated in contact with the sample fluid.

Once the probes are applied (e.g. via ink-jet spotting) onto a surface of the substrate, the addition of an effective amount of a blocking agent in order to inactivate the non-spotted areas of the substrate may be helpful to prevent unspecific binding of target biological compounds or unbound labels to unspotted areas (that would lead to unwanted background signal) and to therefore increase to signal/noise ratio. Examples of suitable blocking substances or agents include, but are not limited to, salmon sperm, skim milk, or polyanions in general.

In another embodiment of the present invention, different labels can be used simultaneously to simultaneously measure:

i) one or more target molecules from different sample fluids (e.g. different sample fluids like blood and sputum or different sample fluids originating from different locations), or

ii) differential expression of analytes from multiple sample fluids (e.g. treated vs. untreated, diseased vs. diseased, etc . . . ), or iii) different types of target molecules from the same sample fluid (e.g. analysis of a blood sample fluid for its DNA and RNA content).

During the actual sensing step, the sample fluid is forced through the porous substrate (e.g. membrane) surface due to the relative movement of said porous substrate with respect to the chamber including the sample. For a better efficiency, the movement of the porous substrate relatively to the chamber containing said sample, during the forcing of the sample fluid through said porous substrate, is preferably performed in a direction substantially perpendicular to the surface of said porous substrate. In order to increase sensitivity and specificity of the subsequent analysis, the aforementioned substrate moving step can be repeated as many times as necessary, at regular or irregular intervals, and either under the same set of conditions (e.g. temperature, pH, or ionic concentration) or under a different set of conditions.

The relative movement of the membrane with respect to the chamber can either be uni-directional or bidirectional, preferably bi-directional. If unidirectional, the substrate is for instance translated once from one side of the chamber to the opposite side of said chamber.

If bidirectional, the substrate is for instance translated back an forth from one end of the chamber to the other.

After each relative movement of the membrane with respect to the chamber, new target molecules have the opportunity to bind to the probes present at the surface of the substrate (e.g. membrane). The movement of the substrate permits:

(i) a shorter diffusion time for a target biomolecule to meet and interact with a probe ; due to the small diameter of the pores, the target molecules come into close vicinity of the previously spotted probes, thus increasing the chances of interaction/hybridization significantly and overcoming the problem of diffusion existing for techniques utilizing non-porous substrates,

(ii) to perform one measurement or probe detection after each relative movement of the membrane with respect to the chamber, in order to follow the kinetics of the binding process, and

(iii) in the case of optical detection, to decrease the distance between the optically transparent window separating the measurement area and the chamber including the sample to be analyzed.

The absence of a pump and its replacement with the concept of moving a porous substrate (e.g. membrane) relatively to the chamber permits to substantially limit, and in most situations to suppress the formation of foam by limiting the possible entries of air into the chamber. In addition, the step where the porous membrane is moved throughout the sample fluid ensures that the sample fluid is mixed and homogenized at the same time.

Quantitatively measuring the presence of labels after a predetermined number of substrate moving steps or cycles, e.g. after each substrate moving step or cycle, may be useful. The results of such quantitative measurements, in combination with the knowledge of the actual substrate and/or sample fluid temperature, permits to determine some of the kinetic properties of the target biological compounds. Heating the sample fluid to a defined temperature allows, through imparting more stringent binding conditions, a more precise control of the binding properties, especially binding specificity. This heating step can also be achieved by heating either the membrane or the sample fluid or both. After the desired temperature has been reached, the sample fluid is then contacted with the substrate.

Sensitivity of the method and/or binding specificity can be increased by suitable means such as, but not limited to:
using appropriate temperature profiles (e.g. a series of one or more heating steps optionally with adequate equilibration times between consecutive heating steps),
adapting the number of substrate moving cycles, and
signal post-processing of the measured label signals (e.g. image processing of fluorescence image) for a measurement series, and
determining the temperatures at which the captured target biological compounds bind optimally or separate again.

For example, when increasing the temperature, a sharp decrease of the measured signal will indicate that the separation (melting) temperature of a given capture probe-target biological compound complex has been reached. This property can be used to distinguish between specific and unspecific binding. To even further improve specificity, the measurement cycle can the be continued after exceeding the melting temperature threshold, this time with continuously decreasing temperatures in order to confirm that re-binding of the target biological compounds occurs again below appropriate specific melting temperature.

An optional final step of the method consists then in removing residual sample fluid from the detection chamber in order to further decrease the background signal due to unbound labels and/or molecules.

The detection chamber geometry is preferably designed in such a way that unbound labels and/or molecules are shielded from the detection system during measurement, e.g. (in the case of labels being luminescent molecules) through obstruction of the optical path for the light emitted from the sample fluid below the membrane or by moving the membrane close to the optically transparent window and thereby chasing away the supernatant. The background signal can be further reduced by whipping the supernatant by a built-in whipper. The removal of the sample fluid as well as the design of the detection chamber geometry ensure that the substrate surface facing the detection system as well as the opposite side of the membrane have a minimal amount of sample fluid as surface layers. This reduces the background signal from unbound labels and/or unbound molecules.

After a suitable contact time of the substrate with the sample fluid, e.g. after a suitable of membrane moving cycles, the labels of the target biological compounds bound to the probes are detected and measured. Additionally, the labels may also be measured during the movement of the membrane.

The physical location, the nature and the intensity of each signal observed permits to identify which target biological compound has been captured, to identify from which sample this target biological compound originates and/or to which type(s) of biological compound it belongs and to assess its concentration.

Analysis of the substrate in the final step of the method of the invention may be performed via an optical set-up comprising an epi-fluorescence microscope and a CCD (charged coupled device) camera or any other kind of camera. This optical set-up preferably comprises a (preferably UV) light source capable of exciting the labels at their respective excitation wavelength, in the case of fluorescent or phosphorescent labels.

The detection of chemioluminescent labels is for instance performed by adding an appropriate reactant to the label and observing its fluorescence via the use of a microscope.

The detection of radioactive labels is for instance performed by the placement of medical X-ray film directly against the substrate which develops as it is exposed to the label and creates dark regions which correspond to the emplacement of the probes of interest.

The detection of enzymatic labels is for instance performed by adding an appropriate substrate to the label and observing the result of the reaction (e.g. colour change) catalyzed by the enzyme.

The detection of calorimetric labels is for instance performed by adding an appropriate reactant to the label and observing the resulting appearance or change of colour.

The detection of sonic microbubble labels is for instance performed by exposing said labels to sound waves of particular frequencies and recording the resulting resonance.

The detection of magnetic beads is for instance performed by magnetic sensor(s).

The method of the present invention has been described herein above by reference to a significant number of parameters, each of them including the possible selection of preferred, or even more preferred, values or embodiments. It should be understood that, unless explained otherwise with respect to certain combination of parameters, each preferred range or embodiment for one such parameter may be combined at will with each preferred range or embodiment for one or more other parameters.

1. A method of preparing a sensor for the analysis of a sample fluid containing one or more target molecules, wherein said method comprises:
introducing said sample fluid into a chamber equipped with a porous substrate, one or more probe molecules being applied to said porous substrate and said probes being able to specifically bind to said one or more target molecules, and
moving said substrate and said chamber relatively to each other in order to force said sample fluid through the pores of said porous substrate and to capture the one or more target molecules with the one or more probe molecules.

2. A method according to claim 1, wherein the relative moving of said porous substrate and said chamber is performed in a direction perpendicular to the surface of said porous substrate.

3. A method according to claim 1, wherein said porous substrate contains a multiplicity of discrete and isolated regions across a surface thereof, each of said regions binding a probe molecule.

4. A method according to claim 1, wherein said substrate comprises a polymer.

5. A method according to claim 1, wherein said substrate comprises a polyamide homopolymer or copolymer.

6. A method according to claim 5, wherein said polyamide homopolymer or copolymer is modified by introduction of quaternary ammonium, solvolysis, or derivatization of amide groups into amidine groups.

7. A method according to claim 1, wherein said substrate comprises a cellulosic material.

8. A method according to claim 1, wherein said substrate. comprises a thermoplastic fluorinated polymer.

9. A method according to claim 1, further comprising a step of analyzing said porous substrate so as to determine the presence and/or concentration of said one or more target molecules.

10. A sensor comprising:
a chamber including a porous substrate with one or more probe molecules applied thereto,
means for introducing a sample fluid containing one or more target molecules into said chamber, and
means for moving said porous substrate relatively to said chamber.

11. A sensor according to claim 10, additionally comprising means for analyzing said porous substrate so as to determine the presence and/or concentration of said one or more target molecules.
